(19) United States
(12) Patent Application Publication
(10) Pub. No.: US 2023/0220168 A1
(43) Pub. Date: Jul. 13, 2023

(54) METHOD OF MANUFACTURING FILLED POLYURETHANE PARTICLES

(71) Applicant: Covestro Deutschland AG, Leverkusen (DE)

(72) Inventors: Dirk Achten, Leverkusen (DE); Joerg Tillack, Leverkusen (DE); Ann-Christin Bijlard-Jung, Leverkusen (DE); Fabian Schuster, Leverkusen (DE)

(21) Appl. No.: 17/997,571

(22) PCT Filed: May 12, 2021
(86) PCT No.: PCT/EP2021/062577

§ 371 Date: Oct. 31, 2022

(30) Foreign Application Priority Data
May 19, 2020 (EP) 20175369.6

(51) Int. Cl. C08J 3/215; C08J 3/14; C08K 3/36; C09D 175/06; C09D 7/61; C09D 7/40; C09J 175/06; C09J 11/04

(52) U.S. Cl. CPC C08J 3/215; C08J 3/14; C08K 3/36; C09D 175/06; C09D 7/61; C09D 7/68; C09D 7/69; C09J 175/06; C09J 11/04; C08J 2375/06; C08K 2201/005

(57) ABSTRACT

The present invention relates to a method of manufacturing a solids-incorporating polymer comprising the steps of: I) providing an aqueous polymer dispersion, the dispersion comprising crystallizing polyurethane particles having a mean particle size of ≤500 nm and further comprising inorganic particles; II) storing the dispersion of step I) at a temperature of ≤0° C. until a precipitate is formed; III) Isolating the precipitate of step II) and IV) removing water from the isolated precipitate of step III), thereby obtaining a water-depleted precipitate. The invention also relates to a solid particulate composition which is obtainable by the method and the use of the composition as a build material in additive manufacturing processes, as a coating, an adhesive or as a rubber.

The present invention relates to a method of manufacturing a solids-incorporating polymer comprising: I) providing an aqueous polymer dispersion, the dispersion comprising polymer particles having an intensity-based harmonic mean particle size of the hydrodynamic diameter (Z-Average), as determined by dynamic light scattering, of ≤500 nm; II) storing the dispersion of step I) at a temperature of ≤0 ° C. until a precipitate is formed; III) Isolating the precipitate of step II) and IV) removing water from the isolated precipitate of step III), thereby obtaining a water-depleted precipitate. The invention also relates to a solid particulate composition which is obtainable by the method and the use of the composition as a build material in additive manufacturing processes, as a coating or an adhesive.

Polymer dispersions can be modified with particulate dispersions of inorganic particles in water, e.g. silica dispersions, and the resulting mixture is usually applied to a substrate. After evaporation of the liquid components a dry film is obtained and the added inorganic particulate is embedded into the film. This has the disadvantage that the mixtures may not be storage stable and the mixture is only available in the liquid form. Furthermore, the layer thickness of an applied coating or adhesive is limited when starting from a liquid formulation.

US 2008/171208 A1 relates to adhesives based on aqueous dispersions and surface-deactivated isocyanate particles and to latently reactive coatings, films and powders produced from such dispersions. The adhesives are prepared from aqueous compositions containing a) dispersed polymers with isocyanate-reactive groups; b) at least one dispersed surface-deactivated aliphatic solid polyisocyanate with a softening temperature of ≥40° C.; c) one or more compounds of elements from subgroups 5 and 6 of the periodic system of elements, in which the particular element has an oxidation number of at least +4 and, d) optionally further additives and auxiliaries.

In US 2008/171208 A1 it is disclosed that a dispersion “2” (comparison) and a dispersion “4” (according to the invention in US 2008/171208 A 1) were stored in a freezer for 24 hours at −5° C. and that the polymer precipitated in the form of coarse solid particles. The formulation was heated to room temperature and the precipitated polymer was separated from the serum by filtration. The polymer was then dried under mild conditions and ground to a particle size of d50 approx. 100 μm in a jet mill with cooling. It should be noted that the presence of a filler such as silica is not disclosed in this publication.

US 2013/245163 A1 describes a process for preparing aqueous compositions, particularly aqueous dispersions based on silicon dioxide, and for preparing adhesive or coating formulations using the aqueous compositions as a component, and for production of adhesive layers and bonding of substrates coated on one side or both sides by spray application using the compositions.

WO 2019/158599 A1 discloses a method for applying a meltable polymer above its decomposition temperature. In the experimental section the freezing of certain Dispercoll® U type polyurethane dispersions at −18° C. for 12 h, followed by filtering the precipitate, drying, sieving and extruding into a filament, is described.

U.S. Pat. No. 6,451,963 B1 relates to a process for the coagulation of PU dispersions, the coagulation products thus obtained and the use of the coagulated PU dispersions. Reactive or post-crosslinkable PU dispersions are suitable as PU dispersions for the process according to the invention. The processes according to the publication comprise the production of films, the coating of many different materials and the partial or complete impregnation of nonwoven, knitted or other fabrics for strengthening purposes. In particular, a process for the coagulation of a post-crosslinkable dispersion, comprising precipitating the post-crosslinkable dispersion by thermal treatment between 50 and 120° C., and forming a stable, at least partly crosslinked polyurethane or gel, is disclosed.

US 2016/280809 A1 describes a continuous or semi-continuous freeze coagulation process for aqueous polymer dispersions, wherein said process comprises a freezing step and a solid-liquid separation step and is further characterized in that it comprises the further step of admixing water and/or water vapor between the freezing step and the solid-liquid separation step.

US 2012/101216 A1 discloses a method for producing polymeric solids free of auxiliary emulators starting from polymer latices (dispersion), wherein a polymer dispersion with a starting ph-value greater than 9 is set to a ph-value of 6 to 9 by adding gaseous carbon dioxide and the polymer dispersion is subsequently coagulated by shearing and/or freezing.

US 2003/088045 A1 is concerned with the use of aqueous isocyanate-free polyurethane dispersions with a solids content of ≥30 wt. % and a solvent content of ≤10 wt. % in formulations for crack sealing coating systems. Said use may be in a) primer, floating screed, floor coatings, spray coatings and/or sealants, on, preferably, primed building surfaces, b) roof coatings or paints and c) sealing of open-cast or subterranean mines. According to the publication, the disclosed polyurethane dispersions are not just more environmentally-friendly and easier to use, but also give a partly improved product property to the corresponding crack sealing coating systems, such as, for example, mechanical properties (tensile strength, stretching under tension, tear elongation), UV resistance and colour stability. Certain examples include Silitin® Z 89 (silica, mixture of quartz and kaolinite).

GB 2269179 A discloses a process for the preparation of toner compositions which comprises dissolving a polymer, and optionally a pigment in an organic solvent; dispersing the resulting solution in an aqueous media containing a surfactant, or mixture of surfactants; stirring the mixture with optional heating to remove the organic solvent thereby obtaining suspended particles of about 0.05 micron to about 2 microns in volume diameter; subsequently homogenizing the resulting suspension with an optional pigment in water and surfactant; followed by aggregating the mixture by heating thereby providing toner particles with an average particle volume diameter of from between about 3 to about 50 microns, and preferably from about 3 to about 21 microns, when said pigment is present.

US 2004/058268 A1 discloses a toner process involving mixing a colorant dispersion and a metal oxide with a latex emulsion comprised of polymer, water, and an anionic surfactant, adding a cationic coagulant followed by heating the mixture to a temperature below about the glass transition temperature (Tg) of the latex polymer particles to provide toner size aggregates comprised of polymer pigment and dye, heating above about the Tg of the polymer and isolating the resulting product.

EP 1783170 A1 discloses a thermoplastic molding composition. This thermoplastic molding composition is produced from a graft copolymer and a thermoplastic polymer. The graft copolymer is produced from a soft elastomeric particulate graft base with a glass transition temperature below 0° C. obtained by emulsion polymerization of a conjugated diene alone or with a small amount of a monoethylenically unsaturated monomer or of at least one C1-C18-alkyl acrylate, or of mixtures of these, upon which is grafted a vinyl aromatic monomer and acrylonitrile and optionally another monoethylenically unsaturated monomer. The aqueous latex of the graft copolymer is mixed with a dispersion of a finely divided inert material in an aqueous medium. For the dispersing step of the finely divided inert material in aqueous solution, a salt of an amphiphilic polymer is used.

GB 2128623 A discloses polymer latices which are coagulated and dewatered by a process comprising: (a) freezing said latex to coagulate the polymer particles therefrom; (b) thawing the resulting coagulum and free water; and (c) separating the free water from the coagulum. The process is reported to be particularly suited to latices of grafted polybutadiene.

U.S. Pat. No. 3,228,905 A discloses a latex containing dispersed individual particles which comprise agglomerated butadiene hydrocarbon polymer having entrapped therein individual particles of inorganic reinforcing pigment which agglomerated particles are formed by the coalescence of dispersed butadiene hydrocarbon polymer particles and the entrapment of individual particles of reinforcing pigment by the coalescing butadiene hydrocarbon polymer particles as they coalesce to form new larger dispersed butadiene hydrocarbon polymer particles.

WO 92/13027 A2 discloses fine polymer particles and polymer-encapsulated particles which are formed by dissolving a polymer in a selective solvent, either lowering the temperature of the solution and/or adding thereto, a non-solvent for the polymer precipitating the polymer from the solution. Particulate material may be included when the solution is formed so that when the polymer precipitates out of the solution, the polymer encapsulates the particulate material. Two homopolymers are placed in solution with the selective solvent so that one polymer precipitates first out of the solution and is suspended therein, the other polymer is precipitated later out of the remaining solution, encapsulating the one polymer particles, forming core/shell polymer particles. Pigments, liposomes and other particulate material can be polymer encapsulated, the polymer and polymer-encapsulated particles being uniform in size and morphology.

EP 2289981 A2 discloses methods for incorporating a dye into latex particles via a supercritical fluid microencapsulation technique, in order to achieve improved dispersion of a colorant in the latex and an increase in color gamut.

The present invention has the object of providing a widely applicable method of incorporating particulate materials into polymers where the end-product is a filled polymer solid.

Accordingly, a method of manufacturing a solids-incorporating polymer comprises:
I) Providing an aqueous dispersion, the dispersion comprising polymer particles having an intensity-based harmonic mean particle size of the hydrodynamic diameter (Z-Average), as determined by dynamic light scattering, of ≤500 nm;
II) Storing the dispersion of step I) at a temperature of ≤0° C. until a precipitate is formed;
III) Isolating the precipitate of step II);
IV) Removing water from the isolated precipitate of step III), thereby obtaining a water-depleted precipitate.

The dispersion of step I) further comprises inorganic particles and the polymer is a crystallizing polyurethane.

It has surprisingly been found that in the method according to the invention the precipitated polymer has also encompassed the inorganic particles. These inorganic particles are therefore incorporated into the polymer material. Hence, a simplified method of compounding polymers with particulate fillers without the need of heating the polymer and adding the inorganic particles to the molten polymer is disclosed.

The aqueous dispersion which is provided in step I) may be based on a commercially available polymer dispersion to which the inorganic particles have been added. The polymer particles dispersed within the aqueous phase have an intensity-based harmonic mean particle size of the hydrodynamic diameter (Z-Average), as determined by dynamic light scattering, of ≤500 nm. Preferred mean particle sizes are ≥10 nm to ≤350 nm and more preferred ≥20 nm to ≤250 nm. The dispersion may also contain customary adjuvants such as emulsifiers. Furthermore, the dispersion may have acids, bases or a buffer system to set the pH value to a desired level. Preferred are pH values of 4 to 10. Lastly, water soluble electrolytes such as metal halogenides, oxides or carbonates may be added to influence electrostatic properties such as the zeta potential of the polymer particles or the inorganic particles.

In providing the aqueous dispersion of step I) an aqueous dispersion of the inorganic particles may be added to an aqueous polymer dispersion. The aqueous dispersion of the inorganic particles may have a pH of ≤6 or ≥8.

In step II) of the method the inorganic particle-containing dispersion is stored at a temperature of 0° C. or less until a precipiate is formed. This precipitate contains the polymer of the polymer particles as well as the inorganic particles. In a simple but efficient manner, step II) can be conducted by storing drums of polymer dispersion to which the inorganic particles have been added in a walk-in freezer or a commercial cold storage facility.

The isolation step III) serves to remove the bulk of the aqueous phase and to obtain a (wet) precipitate for further handling. Commonly used processes for separating solids from liquids may be employed. The residual aqueous phase may have a solids content of ≤5 weight-%, preferably ≤2 weight-%, more preferred ≤1 weight-% and most preferred ≤0.5 weight-%.

Step IV) is a drying step in which the water content of the precipitate is further reduced. This can yield a free-flowing powder or granules. Drying may occur by heating, dry air treatment and/or the application of vacuum and by vacuum and/or drying extrusion.

It is stressed that steps III) and IV) may occur consecutively within the same operation. For example, a vacuum filtration of the precipitate where the filter residue is sucked dry on the filter and then washed with a lower-boiling non-solvent (by “non-solvent” a short-term (for instance, one hour) uptake of less than 10% by weight of solvent is meant) such as ethanol or iso-octane and followed by further residence of the precipitate on the filter for a pre-determined time would execute steps III) and IV).

The inorganic particles may be present in the dispersion of step I) in an amount of ≥1 weight-% to ≤50 weight %, based on the total weight of the precipitated and dried dispersion. Preferred are contents of ≥2 weight-% to ≤30 weight %, more preferred ≥3 weight-% to ≤25 weight %.

In an embodiment of the invention the inorganic particles have an intensity-based harmonic mean particle size of the hydrodynamic diameter (Z-Average), as determined by dynamic light scattering, of ≤100 nm. Preferred mean particle sizes are ≥1 nm to ≤80 nm and more preferred ≥5 nm to ≤60 nm.

In a further embodiment of the invention the method further comprises:
V) Grinding the water-depleted precipitate of step IV) into a particles with a number-based mean particle size, as determined by optical microscopy, of ≤500 μm.

Preferred mean particle sizes after grinding are ≥10 μm to ≤250 μm and more preferred ≥20 μm to ≤150 μm. Examples for grinding methods are dry grinding and cryogrinding. Suitable temperatures should be below the melting point; preferably ≤40° C. below the melting point and more preferably below the glass transition temperature of the polymer material. The grinding in step V) may be conducted at a temperature of ≥−190° C. to ≤40° C.

It is also possible for the grinding process of step V) to take place in a repeated process between grinding rolls with a continuously reduced gap size until the intended particle size is achieved.

In another embodiment the grinding process of step V) is conducted in customary ball mills Alternatively, the grinding process of step V) is conducted in conical mills or pin mills or other common powder and grinding mills.

In a further embodiment of the invention the dispersion of step I) has a polymer solids content of ≥20 weight-% to ≤60 weight-%, based on the total weight of the dispersion. Preferred are polymer solids contents of ≥30 weight-% to ≤55 weight-% in accordance with commercially available polymer dispersions.

In a further embodiment of the invention step II) is conducted at a temperature of ≥−40° C. to ≤−8° C.

In a further embodiment of the invention step III) comprises a filtration step and/or a decanting step. The decanting step is preferred. While decanting will result in a rather wet isolated precipitate, it is a very easy operation and can be performed at a different location than the water removal step IV). Hence, the bulk of the aqueous phase can be removed very cost-effectively and the combined isolated precipitates of several steps III) can be transferred to a more energy-intensive step IV).

In a further embodiment of the invention step W) is conducted at a temperature of ≤2° C. Preferably the temperature is ≤0° C. This may take place in the context of a freeze-drying step.

In a further embodiment of the invention the water-depleted precipitate of step IV) has a water content of ≥0.1 weight-% to ≤5 weight-%, based on the total weight of the water-depleted precipitate. Preferred is a water content of ≥0.1 weight-% to ≤2 weight-%.

In a further embodiment of the invention the water-depleted precipitate of step IV) has an inorganic particle content of ≥2 weight-% to ≤50 weight-%, based on the total weight of dried precipitate. Preferred are particle contents of ≥5 weight-% to ≤30 weight-%.

Examples for suitable polyurethane polymers include anionically hydrophilicized polyurethanes, cationically hydrophilicized polyurethanes and nonionically hydrophilicized polyurethanes. Polyurethanes without internal hydrophilicizing groups may be emulsified by adding external emulsifiers to the dispersion. Preferred are nonionic polyethylene glycol-based emulsifiers.

Also suitable are linear polyester polyurethanes produced by reaction of a) polyester diols having a molecular weight above 600 and optionally b) diols in the molecular weight range of 62 to 600 g/mol as chain extenders with c) aliphatic diisocyanates, while observing an equivalent ratio of hydroxyl groups of components a) and b) to isocyanate groups of component c) of 1:0.9 to 1:0.999, wherein component a) consists to an extent of at least 80% by weight of polyester diols in the molecular weight range of 1500 to 3000 based on (i) adipic acid and (ii) 1,4-dihydroxybutane and/or neopentyl glycol.

It is further preferred that component c) comprises IPDI and also HDI. It is also preferred that the alkanediols b) are selected from the group consisting of: 1,2-dihydroxyethane, 1,3-dihydroxypropane, 1,4-dihydroxybutane, 1,5-dihydroxypentane, 1,6-dihydroxyhexane or a combination of at least two of these in an amount of up to 200 hydroxyl equivalent percent based on component a).

The polyurethanes may also comprise urea groups and therefore also be regarded as polyurethane/polyurea compounds.

The polyurethanes are of the crystallizing type, i.e. they at least partially crystallize after drying of the dispersion. At least partial crystallinity of the material can be established by the presence of a melting peak in a differential scanning calorimetry (DSC) measurement, second heating, at a heating rate of 20 K/min. The melting peak of the polyurethane material preferably is at a temperature of 20° C. or greater, more preferred 50° C. or greater.

In a further embodiment of the invention the polymer in the dispersion of step I) has a number-average molecular weight Mn, determined by gel permeation chromatography, of ≥30000 g/mol. This is particularly preferred in the case of polyurethane polymers. Polymers with such high molecular weights can usually only be processed into stable dispersions when a low solids content is targeted. This is of no consequence in the method according to the invention as the material is precipitated anyway. Therefore, the method according to the invention expands the scope of materials which can be provided with particulate inorganics.

In a further embodiment of the invention the particles in the dispersion of step I) are selected from:

silicon dioxide, titanium dioxide, aluminum oxide, titanium nitride, tungsten nitride, tungsten carbide, carbon black, graphene, carbon nanotubes, metals, sheet silicates, clays comprising organic cations, non-white metal oxides or a mixture of at least two of the aforementioned particle types.

In a further embodiment of the invention the dispersion of step I) is free from solid polyisocyanates and/or elements from subgroups 5 and 6 of the periodic system of elements in which the particular element has an oxidation number of at least +4. The term “free from” is meant to include that technically unavoidable impurities may be present in the dispersion. However, the deliberate addition of the aforementioned substances is excluded from the scope of this embodiment. By way of example, “free from” may mean a concentration of less than 1 ppm with respect to the substance of interest.

A further aspect of the invention is a solid particulate composition, obtainable by a method according to the invention and wherein the particles of the composition comprise a matrix of a crystallizing polyurethane, wherein the number-based mean particle size of the composition, as determined by optical microscopy, is ≤10 mm and wherein inorganic particles are embedded within the matrix, the embedded particles having a number-based mean particle size, as determined by electron microscopy, of ≤1000 nm.

In a further embodiment of the composition the particles of the composition have a major axis representing the largest dimension of each particle and a minor axis representing the smallest dimension of each particle, the dimensions being determined by optical microscopy, the average ratio of major axis length to minor axis length is ≥1:0,01 to ≤1:1, (preferably ≥1:0,05 to ≤1:0,5) and the number-based mean particle size, as determined by optical microscopy, is ≤10 mm

A further aspect of the invention is the use of a composition according to the invention as build material in an additive manufacturing process, as a coating, as an adhesive or as a rubber. Examples for additive manufacturing or 3D printing processes include extrusion-based methods such as fused deposition modeling (1-DM) or free-form fabrication (FFF) and powder-based methods such as selective laser sintering (SLS) and selective laser melting (SLM).

Examples for coating applications include applications in the form of hot melts, hot melt foils, hot melt powders or in the form a solution of the material in a solvent such as acetone, methyl ethyl ketone, (cyclo)hexane, (iso)heptane, (iso)octane, toluene, methylene chloride, dimethyl carbonate, diethyl carbonate, ethyl acetate, propyl acetate, butyl acetate or mixtures thereof.

Examples for rubber applications include the use as a rubber compound material for blending with further ingredients like oils, stabilizers, further fillers, crosslinking agents in standard rubber mixing equipment and as a rubber material after performing a curing operation at temperatures ≥120° C., preferably ≥130° C. and more preferred ≥140° C.

### EXAMPLES

The present invention will be further described with reference to the following examples without wishing to be bound by them.

Methods

The room temperature (RT) was 23° C. Unless noted otherwise, all percentages are weight percentages based on the total weight. Rheological parameters (G′, G″) were measured using a plate/plate oscillation viscosimeter according to ISO 6721-10 at 60° C. and an angular frequency of 1/s. Further measurements were taken every 30 seconds with the temperature falling at 4 K/min until a temperature of 20° C. was reached. At 20° C. the temperature was held constant for 60 min and measurements were taken every 30 seconds.

Polymer Dispersions

Polymer dispersion A was a crystallizing polyester urethane/urea aqueous dispersion for adhesive applications with a pH of 6,8 with a glass transition temperature of the polymer (DSC, 20 K/min) of −50° C., a melting temperature of the polymer (DSC, 20 K/min) of 49° C. and a solids content of ca. 50 weight-%.

Polymer dispersion B was a crystallizing polyester urethane/urea aqueous dispersion for adhesive applications with a pH of 6,9, a glass transition temperature of the polymer (DSC, 20 K/min) of −51° C., a melting temperature of the polymer (DSC, 20 K/min) of 49° C. and a solids content of ca. 50 weight-%.

Polymer dispersion C was a crystallizing polyester urethane/urea aqueous dispersion for adhesive applications with a pH of 7.1, a glass transition temperature of the polymer (DSC, 20 K/min) of −48° C., a melting temperature of the polymer (DSC, 20 K/min) of 50° C. and a solids content of ca. 50 weight-%.

Polymer dispersion Y was a non-crystallizing aliphatic polyester polyurethane aqueous dispersion with a pH of 7.0 with a glass transition temperature (DSC, 20 K/min) of −4° C. and a solids content of ca. 50 weight-%.

Polymer dispersion Z was a non-crystallizing anionic polycarbonate ester polyurethane aqueous dispersion with a pH of 7.5 and with a glass transition temperature of −36° C. (DSC, 20 K/min) and a solids content of ca. 40%.

The polymers of dispersions A, B and C were linear polyester polyurethanes having terminal hydroxyl groups produced by reaction of a) polyester diols having a molecular weight of 1500 to 3000 g/mol and b) diol chain extenters with c) aliphatic diisocyanates. The component a) comprised a polyester diol in the molecular weight range of 1500 to 3000 g/mol, the component b) 1,4-dihydroxybutane and the component c) IPDI and HDI.

Silica Suspensions

Silica suspension D was an aqueous colloidal suspension of amorphous silicon dioxide with a solids content of ca. 30 weight-%, a mean particle size of ca. 9 nm and a pH of 10.4.

Silica suspension E was an aqueous colloidal suspension of amorphous silicon dioxide with a solids content of ca. 50 weight-% a mean particle size of ca. 55 nm and a pH of 9.1.

Preparation of Polymer Dispersions further Comprising Silica

Dispersion mixtures were prepared by mixing 500 mL of the polymer dispersion with the desired amount of silica suspension in a stirring cup and stirring at 100 rpm for 5 min. Weight percentages of the silica dispersion content are based on the total weight of the polymer dispersion/silica dispersion mixture. From the resulting mixture 100 g were diverted and the flow time using a DIN 4 cup of the freshly prepared mixture and of the mixture after storing at room temperature for 56 days were determined. The mixture was classified as “instable” if the flow time had increased by more than 30% or particles or coagulate or precipitate were observed.

Further 10 g of the freshly prepared mixture were poured into a teflon cup with a diameter of 10 cm and dried at 60° C. within one day until a firm, dry film was obtained. The film was removed and rheologically examined in a plate/plate oscillation rheometer. These experiments are denoted “dried”.

Further 300 g of the freshly prepared mixture were transferred into a 500 mL plastic screw-top bottle, stored for 48 h at −18° C. and subsequently thawed at room temperature for 24 h. After thawing the resulting coarse-grained polymer suspension was filtered through a 10 μm paper filter and the polymer residue was dried to constant weight in a rotary evaporator at 40 ° C. water bath temperature and 20 mbar pressure. A solid material was obtained. The residual solids content in the filtrate was less than 2 weight-%, as determined gravimetrically after drying for 1 h at 125° C. , based on the originally present solids in the polymer dispersion and silica suspension. These experiments are denoted “precipitated”.

Table 1 with entries 1 to 27 documents the results of rheological testing for material obtained
from polymer dispersions and polymer dispersions comprising silica. “*” denotes comparative
examples. The silica contents are stated as solid contentcalculated from the parent suspensions.

| | | | Solid | | | | | G′ (20° C.) − | |
|---|---|---|---|---|---|---|---|---|---|
| | | Stability of non-dried | content | G′ [Pa] | G′ [Pa] | G′ [Pa] | G′ [Pa] | G′ (100° C.) | G′(20° C.)/ |
| No. | Formulation | mixture after 56 d | filtrate | 100° C. | 71° C. | 50° C. | 20° C. | [Pa] | G′(100° C.) |
| 1* | A dried | Stable | | 7.0E+04 | 1.7E+05 | 3.1E+05 | 7.0E+05 | 6.3E+05 | 9.9 |
| 2* | B dried | Stable | | 2.0E+05 | 3.8E+05 | 5.7E+05 | 1.0E+06 | 7.9E+05 | 4.9 |
| 3* | C dried | Stable | | 5.3E+05 | 7.0E+05 | 8.6E+05 | 1.2E+06 | 6.3E+05 | 2.2 |
| 4* | B with 3% D | Stable | | 2.2E+05 | 4.2E+05 | 6.4E+05 | 1.1E+06 | 8.4E+05 | 4.7 |
| | dried | | | | | | | | |
| 5* | B with 6% D | Stable | | 2.6E+05 | 4.9E+05 | 7.5E+05 | 1.3E+06 | 9.9E+05 | 4.7 |
| | dried | | | | | | | | |
| 6* | B with 13% D | Stable | | 5.7E+05 | 9.9E+05 | 1.5E+06 | 2.5E+06 | 1.9E+06 | 4.4 |
| | dried | | | | | | | | |
| 7* | B with 21% D | Instable, flow time | | 1.8E+06 | 3.0E+06 | 4.4E+06 | 7.5E+06 | 5.7E+06 | 4.2 |
| | dried | increased >30% | | | | | | | |
| 8* | B with 5% E | Stable | | 2.2E+05 | 4.0E+05 | 6.1E+05 | 1.0E+06 | 7.9E+05 | 4.6 |
| | dried | | | | | | | | |
| 9* | B with 10% E | Instable, flow time | | 2.8E+05 | 5.1E+05 | 7.6E+05 | 1.3E+06 | 9.9E+05 | 4.5 |
| | dried | increased >30% | | | | | | | |
| 10* | B with 20% E | Instable, flow time | | 4.4E+05 | 8.3E+05 | 1.3E+06 | 2.1E+06 | 1.7E+06 | 4.9 |
| | dried | increased >30%, | | | | | | | |
| | | sedimentation and | | | | | | | |
| | | coagulation observed | | | | | | | |
| 11* | B with 30% E | Instable, flow time | | 6.7E+05 | 1.2E+06 | 1.9E+06 | 3.3E+06 | 2.7E+06 | 5.0 |
| | dried | increased >30%, | | | | | | | |
| | | sedimentation and | | | | | | | |
| | | coagulation observed | | | | | | | |
| 12* | B with 50% E | Instable, flow time | | 5.0E+06 | 9.3E+06 | 1.5E+07 | 2.9E+07 | 2.4E+07 | 5.7 |
| | dried | increased >30%, | | | | | | | |
| | | sedimentation and | | | | | | | |
| | | coagulation observed | | | | | | | |
| 13* | A precipitated | Not determined | <1% | 7.7E+04 | 1.8E+05 | 3.3E+05 | 6.9E+05 | 6.1E+05 | 8.9 |
| 14* | B precipitated | Not determined | <1% | 2.1E+05 | 3.8E+05 | 5.8E+05 | 9.4E+05 | 7.3E+05 | 4.5 |
| 15* | C precipitated | Not determined | <1% | 5.8E+05 | 7.8E+05 | 9.7E+05 | 1.3E+06 | 6.9E+05 | 2.2 |
| 16 | B with 3% D | Not determined | <1% | 2.1E+05 | 4.1E+05 | 6.3E+05 | 1.1E+06 | 8.7E+05 | 5.1 |
| | precipitated | | | | | | | | |
| 17 | B with 6% D | Not determined | <1% | 2.4E+05 | 4.5E+05 | 6.9E+05 | 1.1E+06 | 8.8E+05 | 4.7 |
| | precipitated | | | | | | | | |
| 18 | B with 13% D | Not determined | <1% | 6.8E+05 | 1.2E+06 | 1.7E+06 | 2.8E+06 | 2.2E+06 | 4.2 |
| | precipitated | | | | | | | | |
| 19 | B with 21% D | Not determined | <1% | 2.8E+06 | 4.2E+06 | 5.9E+06 | 9.5E+06 | 6.7E+06 | 3.4 |
| | precipitated | | | | | | | | |
| 20 | B with 5% E | Not determined | <1% | 1.9E+05 | 3.6E+05 | 5.7E+05 | 9.8E+05 | 8.0E+05 | 5.2 |
| | precipitated | | | | | | | | |
| 21 | B with 10% E | Not determined | <1% | 2.4E+05 | 4.7E+05 | 7.2E+05 | 1.2E+06 | 9.9E+05 | 5.0 |
| | precipitated | | | | | | | | |
| 22 | B with 20% E | Not determined | <1% | 4.2E+05 | 7.7E+05 | 1.2E+06 | 2.0E+06 | 1.6E+06 | 4.8 |
| | precipitated | | | | | | | | |
| 23 | B with 30% E | Not determined | <1% | 6.7E+05 | 1.2E+06 | 1.8E+06 | 3.2E+06 | 2.5E+06 | 4.8 |
| | precipitated | | | | | | | | |
| 24 | B with 50% E | Not determined | <1% | 4.2E+06 | 8.0E+06 | 1.3E+07 | 2.3E+07 | 1.9E+07 | 5.5 |
| | precipitated | | | | | | | | |
| 25 | A with 13% D | Not determined | <1% | 2.3E+05 | 5.0E+05 | 9.2E+05 | 2.1E+06 | 1.9E+06 | 9.2 |
| | precipitated | | | | | | | | |
| 26 | A with 20% E | Not determined | <1% | 7.2E+04 | 2.0E+05 | 4.1E+05 | 1.0E+06 | 9.7E+05 | 14.5 |
| | precipitated | | | | | | | | |
| 27 | A with 6% D | Not determined | <1% | 9.5E+04 | 2.6E+05 | 5.0E+05 | 1.2E+06 | 1.2E+06 | 13.2 |
| | and 10% E | | | | | | | | |
| | precipitated | | | | | | | | |

An analysis of the rheological data reveals that the amounts of inorganic particles introduced by freeze-coagulation/precipitation perform similarly in modulus modification (strengthening effect) compared to standard dried film materials. This strengthening behavior is commonly associated with a well distributed filler. It is concluded that a highly homogenous mixture of the inorganic filler particles within the polymer has been achieved in the method according to the invention. This circumvents the need for temperature- and energy intensive mixing processes and allows for efficient introduction of fillers with a high surface area at low mixing energies.

Further comparative examples (28* and 29*) were undertaken with the dispersions Y and Z and 10 weight-% respectively of silica suspension D.

In the system of polymer dispersion Y and silica suspension D the precipitate of polymer and silica particles after thawing was observed as a solid rubbery-like block that could not be processed any further. In the system of polymer dispersion Z and silica suspension D no precipitation of polymer and silica particles were observed after freezing, thawing and filtration as the systems stayed liquid after the process.

1. A method of manufacturing a solids-incorporating polymer comprising:
I) Providing an aqueous dispersion, the dispersion comprising polymer particles having an intensity-based harmonic mean particle size of the hydrodynamic diameter (Z-Average), as determined by dynamic light scattering, of ≤500 nm;
II) Storing the dispersion of step I) at a temperature of ≤0° C. until a precipitate is formed;
III) Isolating the precipitate of step II) to obtain an isolated precipitate;
IV) Removing water from the isolated precipitate of step III), thereby obtaining a water-depleted precipitate;
wherein the dispersion of step I) further comprises inorganic particles,
and wherein the polymer is a crystallizing polyurethane.

2. The method according to claim 1, wherein the inorganic particles have an intensity-based harmonic mean particle size of the hydrodynamic diameter (Z-Average), as determined by dynamic light scattering, of ≤100 nm.

3. The method according to claim 1, further comprising:
V) Grinding the water-depleted precipitate of step IV) into particles with a number-based mean particle size, as determined by optical microscopy, of ≤500 μm.

4. The method according claim 1, wherein the dispersion of step I) has a polymer solids content of ≥20 weight-% to ≤60 weight-%, based on the total weight of the dispersion.

5. The method according to claim 1, wherein step II) is conducted at a temperature of from ≥−40° C. to ≤−8° C.

6. The method according to claim 1, wherein step III) comprises a filtration step and/or a decanting step.

7. The method according to claim 1, wherein step IV) is conducted at a temperature of ≤2° C.

8. The method according to claim 1, wherein the water-depleted precipitate of step IV) has a water content of from ≥0.1 weight-% to ≤5 weight-%, based on the total weight of the water-depleted precipitate.

9. The method according to claim 1, wherein the water-depleted precipitate of step IV) has an inorganic particle content of from ≥2 weight-% to ≤50 weight-%, based on the total weight of dried precipitate.

10. The method according to claim 1, wherein a polymer of the polymer particles in the dispersion of step I) has a number-average molecular weight Mn, determined by gel permeation chromatography, of ≥30000 g/mol.

11. The method according to claim 1, wherein the inorganic particles in the dispersion of step I) comprise silicon dioxide, titanium dioxide, aluminum oxide, titanium nitride, tungsten nitride, tungsten carbide, carbon black, graphene, carbon nanotubes, metals, sheet silicates, clays comprising organic cations, non-white metal oxides, or a mixture of at least two of the aforementioned particle types.

12. The method according to claim 1, wherein the dispersion of step I) is free from solid polyisocyanates and/or elements from subgroups 5 and 6 of the periodic system of elements in which the particular element has an oxidation number of at least +4.

13. A solid particulate composition, obtained by a method according to claim 1, comprising particles, wherein the particles of the composition comprise a matrix of a crystallizing polyurethane,
wherein a number-based mean particle of the composition, as determined by optical microscopy, is ≤10 mm, and wherein inorganic particles are embedded within the matrix to form embedded inorganic particles having an number-based mean particle size, as determined by electron microscopy, of ≤1000 nm.

14. The composition of claim 13, wherein
the particles of the composition have a major axis representing the largest dimension of each particle and a minor axis representing the smallest dimension of each particle, the dimensions being determined by optical microscopy,
wherein the mean ratio of major axis length to minor axis length is from ≥1:0.01 to ≤1:1,
and wherein the number-based mean particle size, as determined by optical microscopy, is ≤10 mm.

15. A build material in an additive manufacturing process, a coating, an adhesive or a rubber, comprising the solid particulate composition according to claim 13.
